(19) United States
(12) Patent Application Publication
(10) Pub. No.: US 2022/0178871 A1
(43) Pub. Date: Jun. 9, 2022

(54) GAS DETERMINATION DEVICE, GAS DETERMINATION METHOD, AND GAS DETERMINATION SYSTEM

(71) Applicant: TAIYO YUDEN CO., LTD., Tokyo (JP)

(72) Inventors: Manoharan MURUGANATHAN, Ishikawa (JP); Gabriel AGBONLAHOR, Ishikawa (JP); Hiroshi MIZUTA, Ishikawa (JP); Kenichi SHIMOMAI, Tokyo (JP); Masashi HATTORI, Tokyo (JP); Yosuke ONDA, Tokyo (JP)

(73) Assignee: TAIYO YUDEN CO., LTD., Tokyo (JP)

(21) Appl. No.: 17/681,314

(22) Filed: Feb. 25, 2022

Related U.S. Application Data
(63) Continuation of application No. PCT/JP2020/032957, filed on Aug. 31, 2020.

(30) Foreign Application Priority Data
Aug. 30, 2019 (JP) 2019-157961

(51) Int. Cl. G01N 27/414

(52) U.S. Cl. CPC G01N 27/4141

(57) ABSTRACT

A gas determination method uses a sensor having a field-effect transistor structure including a gate electrode, an insulating film formed on the gate electrode, a source electrode and a drain electrode formed on the insulating film, and a graphene layer formed on the insulating film and connecting the source electrode and the drain electrode to each other. The gas determination method includes: supplying gas to the graphene layer; applying a first voltage to the gate electrode for a predetermined period of time; and thereafter measuring a change in a current flowing between the source electrode and the drain electrode when a sweep voltage is applied to the gate electrode, repeating the same current measurement with a second voltage different from the first voltage, and determining the gas based on the measurement results.

### TECHNICAL FIELD

The present invention relates to a gas determination device, a gas determination method, and a gas determination system.

### BACKGROUND ART

The sensor described in Patent Literature 1 has a field-effect transistor (FET) structure including a gate electrode, an insulating film provided on the gate electrode, a graphene film provided on the insulating film, a first electrode, and a second electrode. In the sensor described in Patent Literature 1, before a detection target is measured, a constant voltage is applied between the first electrode and the second electrode, and a gate voltage of the gate electrode is increased or decreased to measures a current value Id. Subsequently, a similar operation is performed during the measurement of a determination target. A change ΔVg in a gate voltage Vg, at which the current value Id is the smallest, before and after the measurement is then used for the determination evaluation of the determination target.

### CITATION LIST

### Patent Literature

Patent Literature 1: 2018-163146

### DISCLOSURE OF INVENTION

### Technical Problem

It is desired to accurately determine the type of gas in a gas sensor.

In view of the above circumstances, it is an object of the present invention to provide a gas determination device, a gas determination method, and a gas determination system that are capable of determining the type of gas.

### Solution to Problem

A gas determination device according to an embodiment of the present invention is a gas determination device using a sensor having a field-effect transistor structure or like device structure including various electrodes, e.g., a gate electrode, an insulating film formed on the gate electrode, a source electrode and a drain electrode formed on the insulating film, and a graphene layer formed on the insulating film and connecting the source electrode and the drain electrode to each other, the gas determination device including a controller, an acquisition unit, and a determination unit.

The controller controls a voltage to be applied to the gate electrode.

The acquisition unit acquires a change in a first current flowing between the source electrode and the drain electrode when a sweep voltage is applied to the gate electrode to which a first voltage has been applied, the sweep voltage changing in a range between the first voltage and a second voltage different from the first voltage, and acquires a change in a second current flowing between the source electrode and the drain electrode when a sweep voltage is applied to the gate electrode to which the second voltage has been applied, the sweep voltage changing in the range between the first voltage and the second voltage.

The determination unit determines a type or concentration of gas adsorbed to the graphene layer on the basis of a measurement result of the change in the first current with respect to the sweep voltage and a measurement result of the change in the second current with respect to the sweep voltage.

A gas determination method according to an embodiment of the present invention is a gas determination method using a sensor having a field-effect transistor structure including a gate electrode, an insulating film formed on the gate electrode, a source electrode and a drain electrode formed on the insulating film, and a graphene layer formed on the insulating film and connecting the source electrode and the drain electrode to each other, the gas determination method including: supplying gas to the graphene layer; applying a first voltage to the gate electrode for a predetermined period of time; measuring a change in a first current flowing between the source electrode and the drain electrode when a sweep voltage is applied to the gate electrode, the sweep voltage changing in a range between the first voltage and a second voltage different from the first voltage; applying the second voltage to the gate electrode for a predetermined period of time; measuring a change in a second current flowing between the source electrode and the drain electrode when the sweep voltage is applied to the gate electrode; and determining a type or concentration of the gas on the basis of a measurement result of the change in the first current with respect to the sweep voltage and a measurement result of the change in the second current with respect to the sweep voltage.

According to such a configuration of the present invention, if the first voltage or the second voltage is applied to the gate electrode, the graphene layer obtains a valence band or a conduction band, so that it is possible to attract the gas to the graphene layer. Subsequently, the sweep voltage is applied to the gate electrode in a state where the gas is attracted to the graphene layer as described above, so that the characteristics of the change in the current flowing between the source electrode and the drain electrode with respect to the sweep voltage, which are obtained when the sweep voltage is applied, can be made unique to each type of gas. Therefore, it is possible to determine the type of gas with high accuracy from the measurement results of the change in the current.

The determining a type or concentration of the gas may include: deciding a first gate voltage that has a voltage value applied to the gate electrode when a current value has a smallest value in the change in the first current; deciding a second gate voltage that has a voltage value applied to the gate electrode when a current value has a smallest value in the change in the second current; and determining the gas on the basis of the first gate voltage and the second gate voltage.

Each of the first voltage and the second voltage may be a constant voltage in a predetermined period of time.

The first voltage may be a negative voltage, and the second voltage may be a positive voltage.

The first voltage and the second voltage may be voltages having an equal absolute value.

The gas determination method may further include irradiating the graphene layer with ultraviolet rays for a predetermined period of time after the gas is supplied to the graphene layer and before the first voltage is applied.

A voltage may be applied to the gate electrode in a state where the sensor is heated.

In order to achieve the above object, a gas determination system according to an embodiment of the present invention includes a sensor and an information processing device.

The sensor has a field-effect transistor structure including a gate electrode, an insulating film formed on the gate electrode, a source electrode and a drain electrode formed on the insulating film, and a graphene layer formed on the insulating film and connecting the source electrode and the drain electrode to each other.

The information processing device includes a controller that controls a voltage to be applied to an electrode of the sensor, and a determination unit that determines gas adsorbed to the graphene layer on the basis of a measurement result of a current flowing between the source electrode and the drain electrode.

The determination unit determines a type or concentration of the gas on the basis of a measurement result of a change in a first current flowing between the source electrode and the drain electrode when a sweep voltage is applied to the gate electrode after a first voltage is applied for a predetermined period of time to the gate electrode of the sensor in which the gas is supplied to the graphene layer, the sweep voltage changing in a range between the first voltage and a second voltage different from the first voltage, and a measurement result of a change in a second current flowing between the source electrode and the drain electrode when the sweep voltage is applied to the gate electrode after the second voltage is applied to the gate electrode for a predetermined period of time.

### Advantageous Effects of Invention

As described above, according to the present invention, it is possible to accurately determine the type or concentration of gas.

### BRIEF DESCRIPTION OF DRAWINGS

FIG. 1 is a schematic diagram showing a configuration of a gas determination system according to an embodiment of the present invention.

FIG. 2 is a diagram of the outline showing a configuration of a gas sensor constituting a part of the gas determination system.

FIG. 3 is a partially enlarged schematic diagram of the vicinity of a graphene layer 15, for describing the states of the graphene layer and CO₂ when a first voltage and a second voltage are applied to a gate electrode.

FIG. 4 shows the charge state of the graphene layer when CO₂ is used as gas.

FIG. 5 is a graph showing a change in current flowing between a source electrode and a drain electrode when a sweep voltage is applied to the gate electrode after the first voltage and the second voltage are applied in the gas determination system.

FIG. 6 show the graphene layer and the amount of charge transfer between gas molecules in the range of charge neutrality point disparity (CNPD) when each of CO₂, C₆H₆, CO, NH₃, and O₂ is used as gas.

FIG. 7 is a graph showing the results of measuring the range of CNPD of acetone and ammonia as gases when the gas concentration is varied using the gas determination system.

FIG. 8 is a flowchart for describing a schematic procedure for gas determination in the gas determination system.

FIG. 9 is a flowchart for describing a gas determination method.

FIG. 10 is a diagram showing the signal waveforms of the first voltage, the second voltage, and a sweep voltage in the gas sensor of the gas determination system.

FIG. 11 is a diagram showing experimental results of the gas sensor.

FIG. 12 is a schematic cross-sectional view showing another configuration example of the gas sensor.

### MODE(S) FOR CARRYING OUT THE INVENTION

Hereinafter, an embodiment of the present invention will be described with reference to the drawings.

[Outline of Gas Determination System]

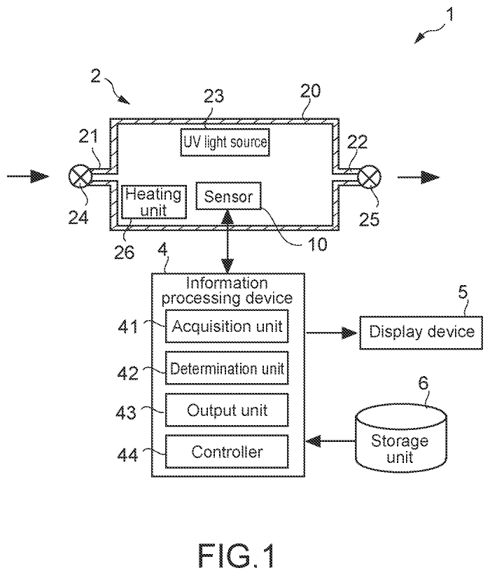

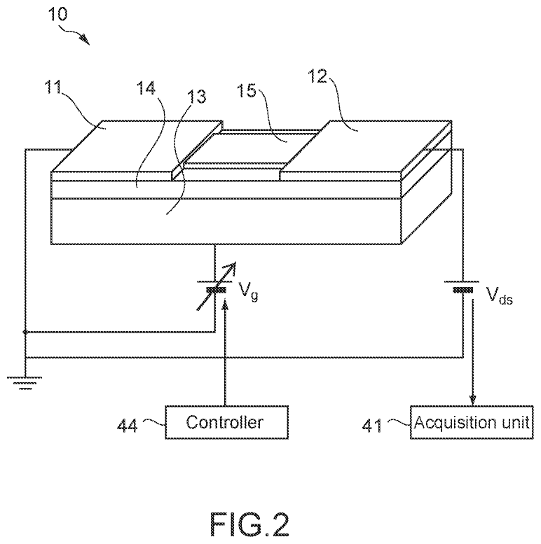

FIG. 1 is a schematic diagram showing a configuration of a gas determination system. FIG. 2 is a schematic diagram showing a configuration of a sensor 10 constituting a part of the gas determination system.

As shown in FIG. 1, a gas determination system 1 includes a sensor device 2, an information processing device 4, a display device 5, and a storage unit 6.

The sensor device 2 includes a housing chamber 20, the sensor 10, an ultraviolet (UV) light source 23, and a heating unit 26.

The housing chamber 20 houses the sensor 10, the UV light source 23, and the heating unit 26. The housing chamber 20 includes an intake port 21 for taking in gas from the outside, and an exhaust port 22 for exhausting gas introduced into the housing chamber 20 from the housing chamber 20 to the outside. The intake port 21 includes a valve 24 for adjusting the inflow of the gas into the housing chamber 20, and the exhaust port 22 includes a valve 25 for adjusting the outflow of the gas in the housing chamber 20 to the outside.

The UV light source 23 emits ultraviolet rays (UV) that are to be applied to the sensor 10. UV is applied to a graphene layer of the sensor 10 to be described later, so that the graphene layer is cleaned.

The heating unit 26 is, for example, a heater and heats the sensor 10.

As shown in FIG. 2, the sensor 10 includes a gate electrode 13, an insulating film 14, a source electrode 11, a drain electrode 12, and a graphene layer 15.

The gate electrode 13 is made of highly doped conductive silicon. The gate electrode 13 is, for example, formed so as to cover the entire surface region of an Si substrate (not shown) whose surface is insulated with a silicon oxide film.

The insulating film 14 is formed on the gate electrode 13. The insulating film 14 is made of, for example, SiO₂.

The graphene layer 15 is patterned on the insulating film 14, for example, in a rectangular shape in plan view and is disposed to face the gate electrode 13 with the insulating film 14 interposed therebetween. The graphene layer 15 is disposed so as to overlap the gate electrode 13 with the insulating film 14 interposed therebetween within the surface region of the gate electrode 13. The graphene layer 15 is formed in a longitudinal rectangular shape in the lateral direction in FIG. 2. In this embodiment, the graphene layer includes a single layer. The graphene layer 15 connects the source electrode 11 and the drain electrode 12 to each other and adsorbs gas in the region sandwiched between the source electrode 11 and the drain electrode 12.

The source electrode 11 and the drain electrode 12 are electrically connected to the graphene layer 15. The source electrode 11 and the drain electrode 12 are laminated on the insulating film 14 so as to cover both end portions of the graphene layer 15 in the longitudinal direction. The source electrode 11 and the drain electrode 12 each have a laminated structure of, for example, a Cr film and an Au film. The source electrode 11 and the drain electrode 12 are disposed to face each other in the lateral direction in FIG. 2 through the graphene layer 15.

Note that a gate extraction electrode to be connected to the gate electrode 13 is formed on the insulating film 14 through a contact hole formed in the insulating film 14. If the gate electrode 13 itself is made of a metal plate, it is possible to omit the silicon substrate and the insulating film thereon and to draw a gate electrode from the back surface thereof.

The information processing device 4 is configured as a gas determination device and includes an acquisition unit 41, a determination unit 42, an output unit 43, and a controller 44. These units 41-44 may be implemented by various known hardware and/or software, and in particular, may be functions executed by one or more processors in the information processing device 4, for example. Thus, these units 41-44 may be functionalities of the information processing device 4, and the information processing device 4 may be one or more processors that perform the corresponding tasks of these units 41-44. In another example, parts or all of the acquisition unit 41 and the controller 44 may be separate hardware different from a processor that functions as the determination unit 42. Various other forms of implementation are possible as long as the below-described functionalities are performed.

As shown in FIG. 2, the acquisition unit 41 acquires change information of the current flowing between the source electrode and the drain electrode. Hereinafter, the current flowing between the source electrode and the drain electrode may be referred to as a drain current.

Referring back to FIG. 1, the determination unit 42 determines the type of gas using the current change information acquired by the acquisition unit 41. Specifically, the information processing device 4 acquires the current change information for each of a plurality of different types of gases in advance, and stores the current change information in the storage unit 6. The determination unit 42 refers to the current change information stored in the storage unit 6, and distinguishes and determines the type of gas detected by the sensor 10. Further, the determination unit 42 is also capable of determining the concentration of gas. This will be described in detail later.

The output unit 43 outputs the current change information acquired by the acquisition unit 41 and a determination result such as the type or concentration of gas, which has been determined by the determination unit 42, to the display device 5.

As shown in FIG. 2, the controller 44 controls the voltage to be applied to the gate electrode 13 of the sensor 10.

The display device 5 includes a display unit and displays the type, concentration, or the like of gas, which has been output from the information processing device 4, on the display unit. A user can know the gas determination result by checking the display unit.

The storage unit 6 acquires in advance the current change information for each of a plurality of known gases of different types, which is detected by the gas determination system 1, and stores the current change information as reference data. The storage unit 6 may be on a cloud server with which the information processing device 4 is capable of communicating or may be provided in the information processing device 4.

(Details of Sensor)

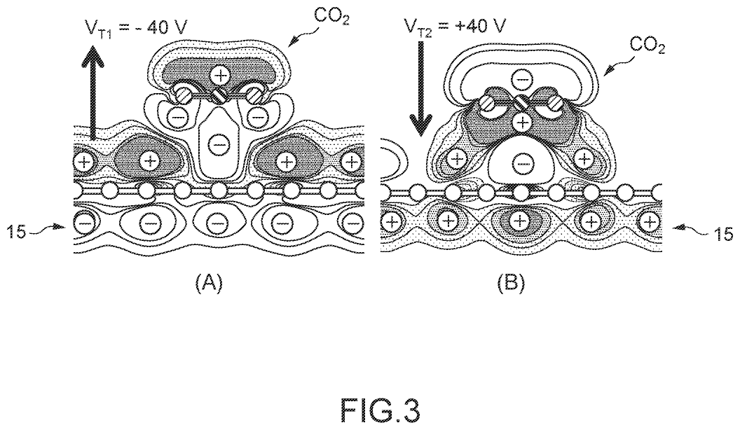

The sensor 10 is a field-effect transistor including the graphene layer 15 as a channel. Each of (A) and (B) of FIG. 3 is a partially enlarged schematic diagram of the vicinity of the graphene layer 15 for describing the charge states of the graphene layer 15 whose state changes in accordance with a voltage applied to the gate electrode 13 and of CO₂ serving as an example of gas adsorbed to the graphene layer 15.

(A) of FIG. 3 shows a case where a first tuning voltage V_{T1} as a first voltage is applied to the gate electrode 13 for a predetermined period of time. In this embodiment, the first tuning voltage V_{T1} is a constant voltage in a predetermined period of time, −40 V. The value of the first tuning voltage V_{T1} is not limited to −40 V and may be a voltage value at which negative charges are supplied to the graphene layer 15 by applying the first tuning voltage V_{T1} and thus the graphene layer 15 has a valence band.

(B) of FIG. 3 shows a case where a second tuning voltage V_{T2} as a second voltage is applied to the gate electrode 13 for a predetermined period of time. In this embodiment, the second tuning voltage is a constant voltage in a predetermined period of time, 40 V. The value of the second tuning voltage V_{T2} is not limited to 40 V and may be a voltage value at which positive charges are supplied to the graphene layer 15 by applying the second tuning voltage V_{T2} and thus the graphene layer 15 has a conduction band.

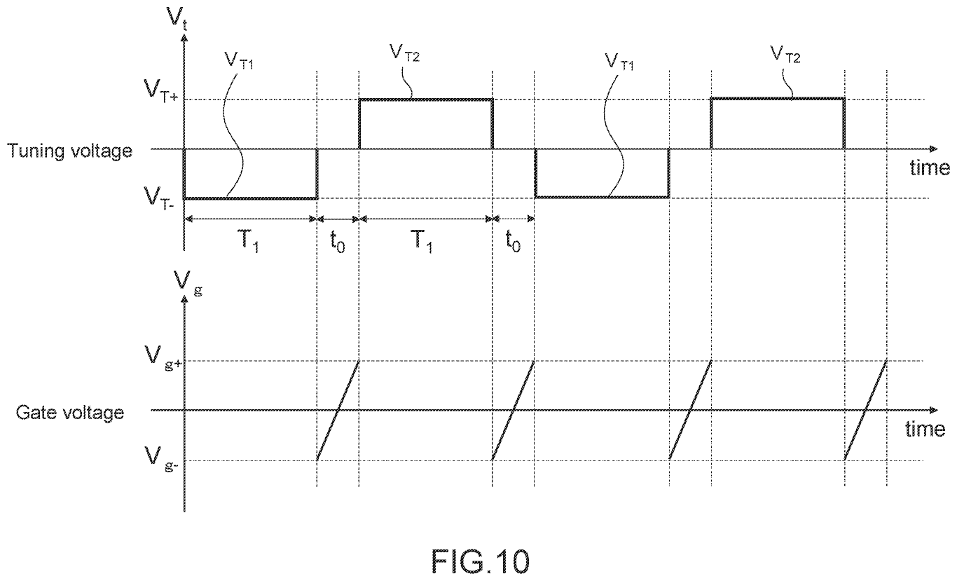

Note that, in this embodiment, an example in which the first and second tuning voltages are each set to a constant voltage and the voltages change in a rectangular waveform as shown in FIG. 10 has been described, but the present invention is not limited thereto. For example, the voltage value may slightly fluctuate within a predetermined period of time, like a delay in the voltage rise or voltage fall or a slight change with gradient of the voltage value. The voltage value may be a voltage value at which the graphene layer 15 has a valence band or a conduction band by the application.

Both of the graphene layer 15 at the time of the first tuning voltage application and the graphene layer 15 at the time of the second tuning voltage application attract gas. As shown in FIG. 3, at the time of the first tuning voltage application and at the time of the second tuning voltage application, the gas molecules adsorbed to the graphene layer 15, in this case, CO₂ molecules, are different in bonding states such as the distance from the graphene layer 15 and a bond angle. Thus, when the first tuning voltage V_{T1} is applied, CO₂ functions as a donor. When the second tuning voltage V_{T2} is applied, CO₂ functions as an acceptor.

When gas is supplied to the graphene layer, and in a state where a voltage is not applied to the gate electrode, it is considered that the gas molecules naturally adsorbed exist in the graphene layer, but the number of gas molecules is very small.

In contrast, in this embodiment, the first tuning voltage and the second tuning voltage are applied to the gate electrode, and thus the gas molecules coming in the vicinity of the graphene layer are guided to the surface of the graphene layer by the electric field indicated by the arrow in FIG. 3, and the gas adsorption is accelerated.

Further, in this embodiment, as shown in FIG. 3, when each of the first tuning voltage and the second tuning voltage is applied, the direction of the electric field in the vicinity of the surface of the graphene layer can be made different, and the bonding states of the gas molecules to the graphene layer can be changed.

The favorable values of the first tuning voltage V_{T1} and the second tuning voltage V_{T2} can be appropriately set depending on the thickness of the insulating film 14. In this embodiment, an insulating film 14 having a thickness of 285 nm is used. In this case, a voltage of approximately −40 V (40 V) is required to provide the graphene layer 15 with a valence band (conduction band).

Further, in order to confirm that the graphene layer 15 switches between the valence band and the conduction band, it is favorable that the first tuning voltage V_{T1} and the second tuning voltage V_{T2} are varied between both the negative side and the positive side. Furthermore, it is more favorable to vary the voltages such that the absolute values of the voltages on the negative side and the positive side become equal.

Further, the application time periods of the first tuning voltage V_{T1} and the second tuning voltage V_{T2} are several seconds to several minutes.

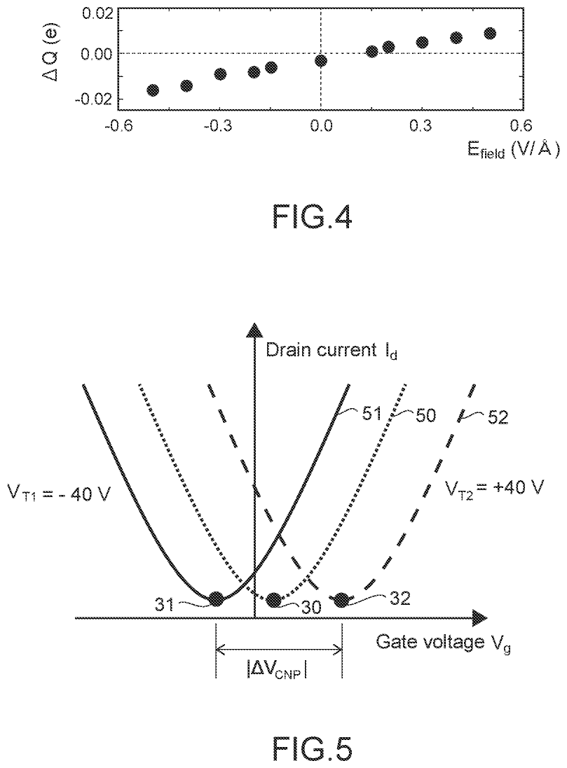

FIG. 4 is a graph showing a change in the charge state of the graphene layer 15 resulting from a change in the electric field between the source electrode 11 and the gate electrode 13 when CO₂ is used as gas. Charge transfer occurs between the CO₂ molecules and the graphene. The vertical axis of FIG. 4 represents ΔQ(e), which is the amount of electrons moved from the CO₂ molecules to the graphene. Whether the voltage to be applied to the gate electrode 13 is set to the first tuning voltage V_{T1} or the second tuning voltage V_{T2} determines whether CO₂ becomes a donor or an acceptor.

FIG. 5 is a graph showing changes in the current flowing between the source electrode 11 and the drain electrode 12 when a sweep voltage is applied to the gate electrode 13 after the first tuning voltage V_{T1} is applied for a predetermined period of time and when the sweep voltage is applied to the gate electrode 13 after the second tuning voltage V_{T2} is applied for a predetermined period of time in the gas determination system 1.

The voltage to be applied to the gate electrode 13 is controlled by the controller 44.

The sweep voltage changes (increases or decreases) in the range between the first tuning voltage and the second tuning voltage different from the first tuning voltage. In this embodiment, a sweep voltage in which the voltage linearly changes from −40 V to 40 V in approximately one minute is used. The sweep voltage therefore changes to encompass both positive and negative sides.

In this embodiment, after the first tuning voltage V_{T1} is applied to the gate electrode 13 of the sensor 10, to which gas has been supplied, for a predetermined period of time, a drain current I_{d} (referred to as a first current I_{d1}) is measured while the sweep voltage is applied to the gate electrode 13.

A solid curve 51 shown in FIG. 5 shows the change characteristics of the first current I_{d1}. In the resulting curve 51, the point at which the first current I_{d1} has the smallest value is referred to as a first charge neutrality point 31. The gate voltage value at which the first current I_{d1} has the smallest value is referred to as a first gate voltage.

As described above, if the first tuning voltage V_{T1} is applied to the gate electrode 13, the graphene layer 15 has a valence band. Thus, the gas is sufficiently attracted to the graphene layer 15, and the gas becomes a donor.

Furthermore, in this embodiment, after the second tuning voltage V_{T2} is applied to the gate electrode 13 of the sensor 10, to which gas has been supplied, for a predetermined period of time, a drain current I_{d} (referred to as a second current I_{d2}) is measured while the sweep voltage is applied to the gate electrode 13.

A dashed curve 52 with a long line length shown in FIG. 5 shows the change characteristics of the second current I_{d2}. In the resulting curve 52, the point at which the second current I_{d2} has the smallest value is referred to as a second charge neutrality point 32. The gate voltage value at which the second current I_{d2} has the smallest value is referred to as a second gate voltage.

In FIG. 5, a dashed curve 50 with a short line length is a curve located at the center between the curve 51 and the curve 52 in the horizontal-axis direction. The point at which the current I_{d} has the smallest value in the curve 50 is referred to as the center point 30.

As shown in FIG. 5, the curve 52 indicating the characteristics of the second current I_{d2} with respect to the sweep voltage (gate voltage Vg) substantially coincides with the shape of the curve 51 moved in the horizontal-axis direction, the curve 51 indicating the characteristics of the first current I_{d1} with respect to the sweep voltage (gate voltage Vg).

In FIG. 5, V_{CNP} represents a gate voltage value at the charge neutrality point, and ΔV_{CNP} represents the difference between the first gate voltage and the second gate voltage.

The inventors have found that the first gate voltage at the first charge neutrality point 31 and the second gate voltage at the second charge neutrality point 32 are unique to each type of gas adsorbed to the graphene layer 15 and that a band indicating the range from the first gate voltage to the second gate voltage differs for each type of gas. This is considered to be because the bonding state of the gas, which functions as an acceptor or donor by being attracted to the graphene layer, with respect to the graphene layer differs for each type of gas.

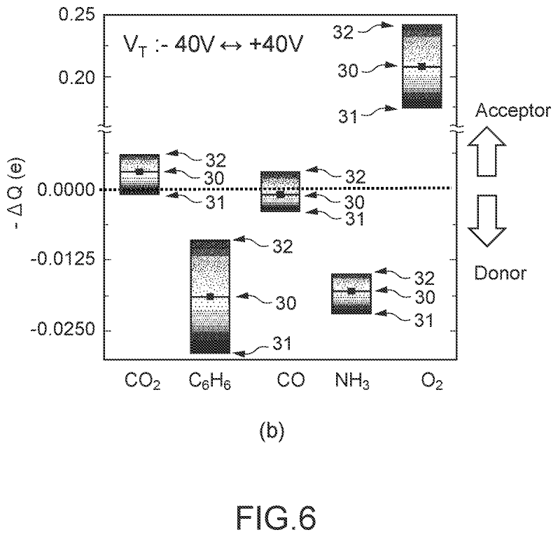

FIG. 6 is a diagram showing that the band indicating the range from the first gate voltage to the second gate voltage differs depending on the type of gas. FIG. 6 shows the bands for respective five types of gases in total: CO₂ (carbon diode); C₆H₆ (benzene); CO (carbon monoxide); NH₃ (ammonia); and O₂ (oxygen). FIG. 6 shows the charge state of the graphene layer in the range of the charge neutrality point disparity (CNPD, which is |ΔV_{CNP}| in FIG. 5). The CNPD represents the difference between the first charge neutrality point 31 and the second charge neutrality point 32 and corresponds to the band. The vertical axis represents −ΔQ(e), the minus of ΔQ(e), which is, as explained above, the amount of electrons moved from the respective gas molecules to the graphene. So, −ΔQ(e) can also be regarded as the amount of electrons moved from the graphene to the gas molecules.

In FIG. 6, a longitudinally extending strip indicates the band indicating the range from the first gate voltage to the second gate voltage. The upper portion of the strip corresponds to the second gate voltage at the second charge neutrality point 32, and the lower portion thereof corresponds to the first gate voltage at the first charge neutrality point 31. The center point 30 is located at the center of the band extending longitudinally. In each band, the upper half from the center point 30 indicates the range in which the gas becomes an acceptor, and the lower half therefrom indicates the range in which the gas becomes a donor.

As shown in FIG. 6, the first gate voltage and the second gate voltage differ depending on the type of gas, and thus, the width and the range of the band differ depending on the type of gas. Therefore, the type of gas can be determined by using this band data.

For example, in this embodiment, the band data of a plurality of known gases are acquired in advance and stored in the storage unit 6. By referring to the data stored in the storage unit 6, it is possible to determine the type of gas from the band data obtained for a gas subject to detection.

In such a manner, by acquiring, as data, the change characteristics of the drain current corresponding to the sweep voltage after application of the two values of −40 V and 40 V of the tuning voltages are acquired as data, it is possible to determine the type of a gas subject to detection.

Furthermore, the inventors have found that the band indicating the range from the first gate voltage to the second gate voltage changes substantially linearly in accordance with a change in the concentration of gas.

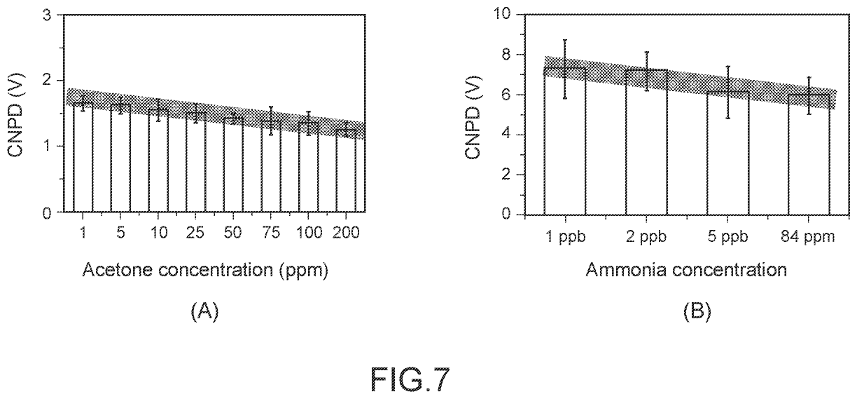

FIG. 7 is a diagram showing the results of varying the concentration of gas and measuring the first gate voltage at the first charge neutrality point 31, which is obtained by applying the sweep voltage after the first tuning voltage is applied, and the second gate voltage at the second charge neutrality point 32, which is obtained by applying the sweep voltage after the second tuning voltage is applied. In the figure, a bar graph indicates a gate voltage value at the center point 30. A longitudinally extending line indicates the band from the first gate voltage to the second gate voltage.

(A) of FIG. 7 shows the case where acetone is used as gas, and (B) of FIG. 7 shows the case where ammonia is used as gas, showing the results of varying the concentration in the range of 1 to 200 ppm.

As shown in FIG. 7, the band indicating the range from the first gate voltage to the second gate voltage changes substantially linearly in accordance with the concentration of gas to be determined, which makes it possible to determine the concentration of gas by using the band.

For example, in this embodiment, the data of bands of known gases having different concentrations are acquired in advance and stored in the storage unit 6. Subsequently, by referring to the data of the storage unit 6, it is possible to determine the concentration of gas from the data of the bands obtained with unknown gases.

[Gas Determination Method]

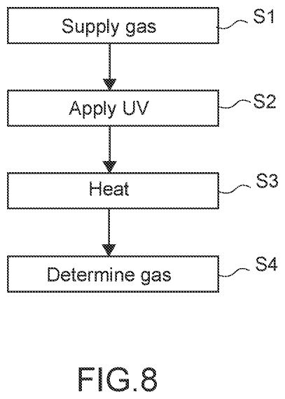

A gas determination method in the gas determination system 1 will be described with reference to FIGS. 8 to 10.

FIG. 8 is a flowchart for describing a schematic procedure for gas determination in the gas determination system 1.

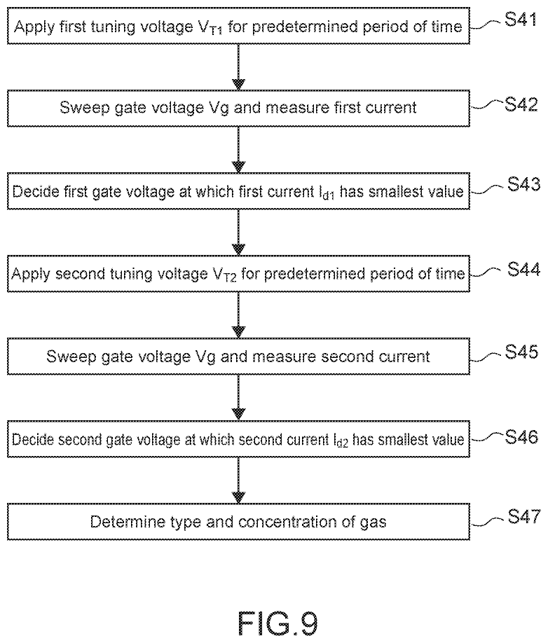

FIG. 9 is a flowchart for describing a gas determination method in the information processing device 44.

FIG. 10 is a diagram showing the signal waveforms of the first tuning voltage V_{T1}, the second tuning voltage V_{T2}, and the sweep voltage applied to the gate electrode. As shown in FIG. 10, the first tuning voltage V_{T1} and the second tuning voltage V_{T2} are step functions with respect to time.

First, as shown in FIG. 8, gas is supplied into the housing chamber 20 (S1). The inside of the housing chamber 20 is at normal pressure. The atmosphere gas in the storage chamber 20 may be atmosphere (air) or ammonia gas.

Note that the inside of the housing chamber 20 is not limited to be at the normal pressure and may be in a reduced-pressure atmosphere. In this case, the air of the housing chamber 20 is exhausted from the exhaust port 22. After the inside of the housing chamber 20 reaches a predetermined pressure (several mTorr), the gas is supplied.

Since the adsorbed gas is desorbed by setting the inside of the housing chamber 20 to a reduced-pressure atmosphere, the charge neutrality point (CNP) of the sensor 10 before the gas is supplied approaches zero, as compared with the atmospheric pressure atmosphere. If the charge neutrality point does not become zero, the sensor 10 may be heated by the heating unit 26 to perform degassing treatment.

Next, UV is applied from the UV light source 23 toward the sensor 10 and the housing chamber 20 for one minute (S2).

By UV irradiation, the gas is efficiently adsorbed to the graphene layer. This is considered to be because, by UV irradiation, O₂, H₂O, and the like are removed from the surface of the graphene layer (cleaning effect), and the dynamic equilibrium between the adsorption of the gas molecules to the surface of the graphene layer and the photoexcited desorption is induced to increase the adsorption sites where the gas is effectively used in the graphene layer, and to accelerate the adsorption by the change in the state (ionization or the like) of the adsorbed molecules.

Next, the sensor 10 is heated by the heating unit 26 (S3). The heating temperature is favorably 95° C. or higher. In this embodiment, the sensor 10 is heated to a heating temperature of 110° C.

By performing UV irradiation and heating, it is possible to more clearly distinguish the curve 51 indicating the change of the first current I_{d1} with respect to the sweep voltage, which is obtained by applying the sweep voltage after the application of the first tuning voltage V_{T1}, from the curve 52 indicating the change of the second current I_{d2} with respect to the sweep voltage, which is obtained by applying the sweep voltage after the application of the second tuning voltage V_{T2}. This will be described in detail later.

Next, gas determination is performed (S4). Details of the gas determination will be described below with reference to FIGS. 9 and 10.

The gas determination is started from a state where a voltage of 5 to 10 mV is applied between the source electrode 11 and the drain electrode 12. The voltage value applied to each electrode is controlled on the basis of a control signal from the controller 44.

The voltage applied between the source electrode 11 and the drain electrode 12 uses a linear region of the output. If the voltage applied between the source electrode 11 and the drain electrode 12 is too high or too low, noise is generated, and thus it is favorable to set the voltage to 5 to 10 mV at which noise generation is suppressed.

As shown in FIGS. 9 and 10, when the gas determination is started, the first tuning voltage V_{T1} is applied to the gate electrode 13 for a predetermined period of time (S41). In this embodiment, the first tuning voltage V_{T1} of −40 V is applied for several seconds to several minutes.

As a result, the graphene layer 15 has a valence band, the gas is sufficiently attracted to the graphene layer 15, and the gas functions as a donor.

The application time period of the first tuning voltage V_{T1} is appropriately set depending on the thickness of the insulating film 14 or the like. In this embodiment, it is favorably 5 seconds or more, more favorably 30 seconds or more, and favorably 120 seconds or less, and more favorably 60 seconds or less, as long as it is a sufficient time period for the graphene layer 15 to have a valence band. Further, a favorable value can be appropriately set for the application time period depending on the heating temperature of the sensor 10 or the like.

Next, a sweep voltage is applied to the gate electrode 13 to which the first tuning voltage V_{T1} has been applied, and the first current I_{d1} flowing between the source electrode 11 and the drain electrode 12 during the application of the sweep voltage is measured (S42). In this embodiment, the sweep of the voltage is performed at a resolution of 50 mV to 100 mV, in a range of 80 V, and in a sweep time period of one minute. As shown in FIG. 10, the gate voltage is gradually changed from negative to positive, such as from −40 V to 40 V. Note that the gate voltage may be gradually changed from positive to negative, such as from 40 V to −40 V.

The result of measuring the first current I_{d1} with respect to the sweep voltage is obtained by the acquisition unit 41.

Next, the determination unit 42 decides the first gate voltage, which is the gate voltage value at which the first current I_{d1} has the smallest value, on the basis of the measurement result acquired by the acquisition unit 41 (S43).

Next, the second tuning voltage V_{T2} is applied to the gate electrode 13 for a predetermined period of time (S44). In this embodiment, the second tuning voltage V_{T2} of +40 V is applied for several seconds to several minutes.

As a result, the graphene layer 15 has a conduction band, the gas is sufficiently attracted to the graphene layer 15, and the gas functions as an acceptor. The bonding state of the graphene layer 15 and the gas after the second tuning voltage is applied is different from the bonding state of the graphene layer 15 and the gas after the first tuning voltage is applied.

The application time period of the second tuning voltage V_{T2} is appropriately set depending on the thickness of the insulating film 14 or the like. In this embodiment, it is favorably 5 seconds or more, more favorably 30 seconds or more, and favorably 120 seconds or less, and more favorably 60 seconds or less, as long as it is a sufficient time period for the graphene layer 15 to have a conduction band. Further, a favorable value can be appropriately set for the application time period depending on the heating temperature of the sensor 10 or the like.

Next, a sweep voltage is applied to the gate electrode 13 to which the second tuning voltage V_{T2} has been applied, and the second current I_{d2} flowing between the source electrode 11 and the drain electrode 12 during the application of the sweep voltage is measured (S45). In this embodiment, the sweep of the voltage was performed at a resolution of 50 mV to 100 mV, in a range of 80 V, and in a sweep time period of one minute. As shown in FIG. 10, the gate voltage is gradually changed from negative to positive, such as from −40 V to 40 V. Note that the gate voltage may be gradually changed from positive to negative, such as from 40 V to −40 V.

The result of measuring the second current I_{d2} with respect to the sweep voltage is obtained by the acquisition unit 41.

Next, the determination unit 42 decides the second gate voltage, which is the gate voltage value at which the second current I_{d2} has the smallest value, on the basis of the measurement result acquired by the acquisition unit 41 (S46).

Next, the determination unit 42 determines the type and concentration of the gas by referring to the data stored in the storage unit 6 on the basis of the first gate voltage and the second gate voltage decided in S43 and S46 (S47). Note that, although an example in which both the type and the concentration of the gas are determined has been described here, either one of them may be determined.

S43, S46, and S47 correspond to the gas determination steps of determining the gas on the basis of the measurement results of the first current I_{d1} and the second current I_{d2}.

In this embodiment, the step of deciding the first gate voltage V_{g1} at which the first current I_{d1} has the smallest value is provided after the measurement of the first current I_{d1} in S42, but this step may be performed in the step of deciding the second gate voltage V_{g2} at which the second current I_{d2} has the smallest value in S46.

In this embodiment, the UV irradiation and the heating are performed to obtain data in which a curve group 510 indicating the change in the first current I_{d1} with respect to the sweep voltage and a curve group 520 indicating the change in the second current I_{d2} with respect to the sweep voltage can be more clearly distinguished from each other. Thus, it is possible to perform gas determination with higher accuracy.

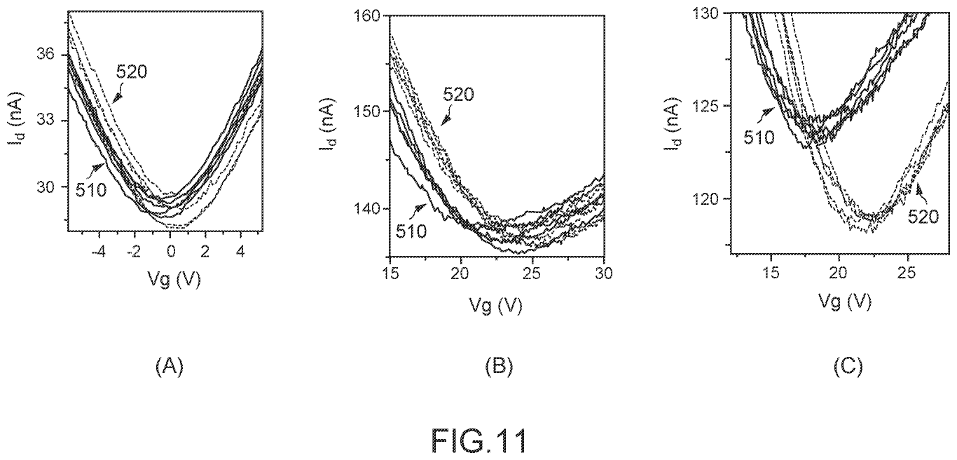

FIG. 11 shows the results of measuring the change in the first current I_{d1} with respect to the sweep voltage and the change in the second current I_{d2} with respect to the sweep voltage, which are obtained when the following series of steps is repeated five times: applying the first tuning voltage; measuring the first current I_{d1} while applying the sweep voltage; applying the second tuning voltage; and measuring the second current I_{d2} while applying the sweep voltage.

In FIG. 11, the solid line is the curve group 510 indicating the characteristics of the drain current (first current) and the gate voltage, which is obtained when the sweep voltage is applied to the gate electrode after the first tuning voltage is applied. The dashed line is the curve group 520 indicating the characteristics of the drain current (second current) and the gate voltage, which is obtained when the sweep voltage is applied to the gate electrode after the second tuning voltage is applied.

(A) of FIG. 11 shows experimental results indicating the change characteristics of the current flowing between the source electrode and the drain electrode with respect to the sweep voltage when the gas determination is performed without UV light irradiation and heating.

(B) of FIG. 11 shows experimental results showing the change characteristics of the current flowing between the source electrode and the drain electrode with respect to the sweep voltage when the gas determination is performed with UV light irradiation and without heating.

(C) of FIG. 11 shows experimental results showing the change characteristics of the current flowing between the source electrode and the drain electrode with respect to the sweep voltage when the gas determination is performed with UV light irradiation and heating.

As shown in (A) of FIG. 11, the curve group 520 indicated by the dashed lines has substantially the form in which the curve group 510 indicated by the solid lines is moved to the right along the horizontal-axis direction in the figure. The difference between the first gate voltage and the second gate voltage when the drain current I_{d} in each curve has the smallest value can be obtained.

As shown in (B) of FIG. 11, in the curve group 520 indicated by the dashed lines, the curve group 510 indicated by the solid lines is moved to the right along the horizontal-axis direction in the figure. The difference between the first gate voltage and the second gate voltage when the drain current Id in each curve has the smallest value can be obtained.

As shown in (C) of FIG. 11, the curve group 520 indicated by the broken lines has the form in which the curve group 510 indicated by the solid lines moves to the right along the horizontal-axis direction in the figure and also moves downward along the vertical axis direction. It is possible to clearly distinguish the curve group 510 and the curve group 520 from each other.

As described above, in any of the figures (A) to (C) of FIG. 11, the curve group 510 indicating the characteristics of the drain current and the gate voltage, which is obtained when the sweep voltage is applied to the gate electrode after the application of the first tuning voltage, and the curve group 520 indicating the characteristics of the drain current and the gate voltage, which is obtained when the sweep voltage is applied to the gate electrode after the application of the second tuning voltage, are deviated in the horizontal-axis direction, and thus the type of gas can be determined by the first gate voltage and the second gate voltage.

In addition, as shown in (C) of FIG. 11, performing the UV irradiation and heating makes it possible to further increase the difference in the horizontal-axis direction between the first gate voltage and the second gate voltage, and thus it is possible to more clarify the band indicating the range from the first gate voltage to the second gate voltage. As a result, it is possible to further improve the determination accuracy for the type of gas.

As described above, in the gas determination method of the present invention, the type or concentration of gas can be determined with high accuracy by using a gas sensor having a field-effect transistor structure with graphene as a channel. Further, it is possible to use a small gas sensor, and thus it is possible to reduce the size of the sensor device 2.

Hereinabove, the embodiment of the present invention has been described, but the present invention is not limited to the embodiment described above. As a matter of course, the present invention can be variously modified without departing from the gist of the present invention.

For example, in the embodiment described above, the gate electrode to which the first and second tuning voltages and the sweep voltage are applied is a common gate electrode, but the present invention is not limited thereto. A gate electrode to which a sweep voltage is to be applied may be provided separately from the gate electrode to which the first and second tuning voltages are to be applied. Both the gate electrodes only need to be disposed to face the graphene layer through the insulating film.

Further, in the embodiment described above, the tuning voltage (fixed voltage) is set to have two values of the first tuning voltage and the second tuning voltage, but it only needs to have at least two values or may have three or more values. When three values or more are set, the information of gas is increased, and more accurate gas determination can be performed.

Further, in the embodiment described above, an example in which the voltage is applied to the gate electrode in the order of the negative first tuning voltage (−40 V in the embodiment described above), the sweep voltage, the positive second tuning voltage (40 V in the embodiment described above), and the sweep voltage has been described, but the voltage may be applied to the gate electrode in the order of the positive second tuning voltage, the sweep voltage, the negative first tuning voltage, and the sweep voltage.

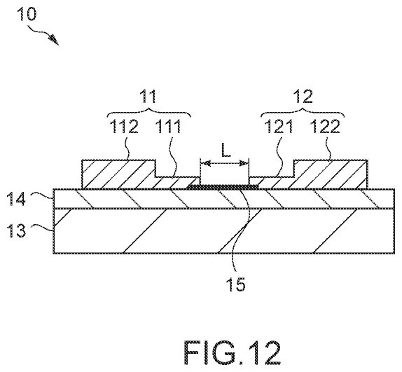

Furthermore, the sensor 10 may be configured as shown in FIG. 12, for example. In the sensor 10 shown in FIG. 12, the source electrode 11 and the drain electrode 12 respectively include first regions 111 and 121 that cover the end portions of the graphene layer 15, and second regions 112 and 122 having thickness larger than that of the first regions 111 and 121.

Both end portions of the graphene layer 15 are disposed so as to be embedded between the insulating film 14 on the gate electrode 13 and the first region 111 of the source electrode 11 and between the insulating film 14 and the first region 121 of the drain electrode 12. The opposing distance L between the first region 111 of the source electrode 11 and the first region 121 of the drain electrode 12 is, for example, 200 nm. In this case, the source electrode 11 and the drain electrode 12 are respectively formed so as to cover both end portions of the graphene layer 15 with the first regions 111 and 121 each having a small thickness, and thus the dimensional management between the source electrode 11 and the drain electrode 12 is facilitated, so that the dimensional accuracy of the graphene layer 15 located between both the electrodes 11 and 12 can be improved.

1. A gas determination device, comprising:
a sensor including
a first electrode,
an insulating film formed on the first electrode,
a second electrode and a third electrode formed on the insulating film, and
a graphene layer for absorbing a gas, formed on the insulating film and electrically connecting the second electrode and the third electrode to each other; and
an information processing device that
acquires a change in a first current that is a current between the second electrode and the third electrode when a sweep voltage is applied to the first electrode after a first voltage has been applied to the first electrode, the sweep voltage changing in a predetermined range, and
acquires a change in a second current that is a current between the second electrode and the third electrode when the sweep voltage is applied to the first electrode after a second voltage different from the first voltage has been applied to the first electrode; and
determines a type or concentration of the gas adsorbed to the graphene layer on a basis of a measurement result of the change in the first current with respect to the sweep voltage and a measurement result of the change in the second current with respect to the sweep voltage.

2. The gas determination device according to claim 1, wherein the information processing device further performs the following:
determining a first application voltage applied to the first electrode at which the first current has a smallest value,
determining a second application voltage applied to the first electrode at which the second current has a smallest value, and
determining the type or concentration of the gas on a basis of values of the first application voltage and the second application voltage.

3. The gas determination device according to claim 1,
wherein the information processing device causes a constant voltage to be applied to the first electrode for a predetermined period of time, as the first voltage, and
wherein the information processing device causes another constant voltage to be applied to the first electrode for the predetermined period of time, as the second voltage.

4. The gas determination device according to claim 1, wherein the information processing device causes a negative voltage to be applied to the first electrode as the first voltage, and causes a positive voltage to be applied to the first electrode as the second voltage.

5. The gas determination device according to claim 4, wherein the first electrode and the second voltage have opposite polarities with a same absolute value.

6. The gas determination device according to claim 1, the information processing device causes information on the acquired changes in the first and second currents and information on the determined type or concentration of the gas to output to a display device.

7. A gas determination method, using a sensor including a first electrode, an insulating film formed on the first electrode, a second electrode and a third electrode formed on the insulating film, and a graphene layer for absorbing a gas, formed on the insulating film and electrically connecting the second electrode and the third electrode to each other, the gas determination method comprising:
supplying the gas to the graphene layer;
applying a first voltage to the first electrode for a predetermined period of time;
thereafter, measuring a change in a first current that is a current between the second electrode and the third electrode when a sweep voltage is applied to the first electrode after the first voltage has been applied to the first electrode, the sweep voltage changing in a predetermined range;
thereafter, applying a second voltage different from the first voltage to the first electrode for a predetermined period of time;
thereafter, measuring a change in a second current that is a current between the second electrode and the third electrode when the sweep voltage is applied to the first electrode after the second voltage has been applied to the first electrode; and
determining a type or concentration of the gas on a basis of a measurement result of the change in the first current with respect to the sweep voltage and a measurement result of the change in the second current with respect to the sweep voltage.

8. The gas determination method according to claim 7, wherein the determining a type or concentration of the gas includes:
determining a first application voltage applied to the first electrode at which the first current has a smallest value;
determining a second application voltage applied to the first electrode at which the second current has a smallest value; and
determining the type or concentration of the gas on a basis of the first application voltage and the second application voltage.

9. The gas determination method according to claim 7, wherein each of the first voltage and the second voltage is a constant voltage during the predetermined period of time.

10. The gas determination method according to claim 7, wherein the first voltage is a negative voltage, and the second voltage is a positive voltage.

11. The gas determination method according to claim 10, wherein the first voltage and the second voltage have an equal absolute value.

12. The gas determination method according to claim 7, further comprising
irradiating the graphene layer with ultraviolet rays for a predetermined period of time after the gas is supplied to the graphene layer and before the first voltage is applied.

13. The gas determination method according to claim 7, wherein the first voltage and the second voltage are respectively applied to the first electrode in a state where the sensor is heated.

14. A gas determination system, comprising:
a sensor including
a first electrode,
an insulating film formed on the first electrode,
a second electrode and a third electrode formed on the insulating film, and
a graphene layer for absorbing a gas, formed on the insulating film and electrically connecting the second electrode and the third electrode to each other; and
an information processing device that determines the gas adsorbed to the graphene layer on a basis of a measurement result of a current between the second electrode and the third electrode,
wherein the information processing device determines a type or concentration of the gas on a basis of a measurement result of a change in a first current and a measurement result of a change in a second current, the first current being a current between the second electrode and the third electrode when a sweep voltage is applied to the first electrode after a first voltage has been applied for a predetermined period of time to the first electrode of the sensor in which the gas has been supplied to the graphene layer, the sweep voltage changing in a predetermined range, the second current being a current between the second electrode and the third electrode when a sweep voltage is applied to the first electrode after a second voltage different from the first voltage has been applied to the first electrode for a predetermined period of time, the sweep voltage changing in a predetermined range.
